(19) United States
(12) Patent Application Publication
(10) Pub. No.: US 2026/0109117 A1
(43) Pub. Date: Apr. 23, 2026

(54) METHOD AND SYSTEM FOR MANUFACTURE OF COMPOSITE STRUCTURE OF WIND TURBINE BLADE

(71) Applicant: Envision Energy Co., Ltd., WUXI (CN)

(72) Inventors: Tommy SOERENSEN, Silkeborg (DK); Jesper BOENDING, Silkeborg (DK); Rasmus OLESEN, Silkeborg (DK)

(73) Assignee: Envision Energy Co., Ltd., WUXI (CN)

(21) Appl. No.: 19/426,067

(22) Filed: Dec. 19, 2025

Related U.S. Application Data
(63) Continuation of application No. PCT/CN2023/102463, filed on Jun. 26, 2023.

(51) Int. Cl. B29C 70/54; B29C 70/38; B29L 31/08

(52) U.S. Cl. CPC B29C 70/54; B29C 70/38; B29L 2031/085

(57) ABSTRACT

The invention relates to a system and method for manufacture of a composite structure (17) of a wind turbine blade (5). Layers of a fibrous material (33) are arranged in a mould (16) and the top surface of the upper layer is scanned using a measuring device (25). The data inputted from the measuring device (25) is analysed in a processor (26) to identify the locations of defects (27) and detailed information thereof. The location data is then transmitted to a lighting system (28), where the locations of the defects (27) are visually indicated on or relative to the upper layer of the composite structure (17) using lighting devices (29). The present inspection method can be performed during dry layup of the respective layers, thereby allows defects (27) to be corrected before infusion of the resin matrix material.

### CROSS REFERENCE TO RELATED APPLICATION

This application is a continuation of International Application No. PCT/CN2023/102463, titled “A METHOD AND SYSTEM FOR MANUFACTURE OF A COMPOSITE STRUCTURE OF A WIND TURBINE BLADE” filed on Jun. 26, 2023, the entire contents of which are incorporated herein by reference.

### FIELD OF THE INVENTION

The present invention relates to a method and system for manufacturing a composite structure of a wind turbine blade, where a measuring device is arranged above a mould with a moulding surface, the measuring device is arranged relative to a moveable tool for laying up a layer of a fibrous material onto the moulding surface or on top of a former layer of a fibrous material, the measuring device is connected to a processor configured to analyse the data from the measuring device and identify a location of a defect in the layer or former layer, wherein the location is visually indicated on or relative to the layers.

### BACKGROUND OF THE INVENTION

It is known for workers to manually inspect the quality of the layup of layers during manufacture of large composite structures, such as wind turbine blades. However, this inspection process is labour and time-intensive and requires quality training personnel. Defects in the laminate or sandwich structure may affect the structural integrity after curing, and lead to added repair work after manufacturing. Visual inspection depends on the skills and knowledge of workers and may lead to a lack of repeatability and accuracy.

EP 2390074 B1 discloses an in-line inspection method for manufacturing prepregs or laminates, where two measurements of the same parameter or different parameters of prepreg or laminate are conducted during the manufacturing process. The measurements may include optical 2D-measurements of the laminate surface topography during layup using imaging techniques. The optical measuring device may be positioned adjacent to the layup head. The captured image data are analysed and evaluated in a processor to identify defects in the prepreg or laminate, such as wrinkles.

The historical data of the prepreg or laminate may be used as input for the processor to predict if defects identified in the prepreg or laminate will be present in the cured part and what effect they will have on the strength of the cured part. The processed data may be used to automatically or manually adjust parameters related to the layup process. However, no details are provided about how the results of the data processing is presented to the workers, or how the layup process parameters are adjusted.

US 2013/0179118 A1 discloses a method and system for inspecting the layup of a wind turbine blade, where to optical metrology devices are arranged at either ends of the moveable layup trolley. The devices are connected to a computer, which generates a two- or three-dimensional data model of the top surface for identifying defects in the laminate during layup. This data model may also be compared to a data model generated after curing of the composite part. It is implied that upon identifying a defect, the defect is then isolated and removed. However, not details of this removal process are provided.

DE 102011051071 A1 discloses a method and imaging system for inspecting a fibre laminate, where electromagnetic waves are emitted towards the fibre laminate by a transmitter and a receiver is receiving the waves reflected by the fibre laminate or the waves transmitted through the fibre laminate. An image recognition algorithm may be implemented in a computer to identify defects in the fibre laminate using the Synthetic Aperture Radar (SAR) principle. The defects are then corrected before the fibre laminate is infused with a resin matrix material. The application implies that the images are displayed to the worker, but further details are not provided.

EP 2991034 A1 discloses a method and system of inspecting a fibre laminate, where a light source and a camera are arranged above the mould. The light source projects a light pattern onto the mould and the camera captures an image of the light pattern. A computer generates then a baseline 3D-profile of the mould. The respective fibre layers are afterwards laid up on the mould. Another 3D profile is generated by projecting light onto the fibre layers and capturing the reflected light pattern. A thickness difference is then calculated between the respective 3D-profiles and compared to a threshold. If the error exceeds limits, then an alarm is generated, and the defect may be corrected. No details are provided about how the alarm information is presented to the workers.

It is also known to use an overhead laser projection system to project reference lines onto the mould or the fibre layers. An example of such laser projection system is disclosed in EP 3645255 A4, where a computer model of the layup order of core panels is generated, from which reference markings for placement of the core panels are extracted. The mould comprises a plurality of reflective markings, which are used to calibrate the laser projection system. Deviations between the projected markings and the core panel may lead to adjustment of the placement of the core panel or adjustment of the projected reference markings. This layup process still requires a manual or automatic inspection for defects.

EP 1955108 B1 discloses a method and system for projecting an image of a defect onto the surface of a workpiece using a laser projecting device. The laser projecting device is connected to a data system or a database, comprising information indicative of defects within the workpiece. The data system uses one or more sensors for collecting data related to the workpiece, which are then later analysed and evaluated in the computer. The data may be downloaded into the database prior to performing the inspection. Encoders and reflective targets are used to determine the orientation and location of the laser projecting devices as well as the rotation angle of the mandrel.

This arrangement is only suited for workpieces that are rotated during manufacturing, such as disclosed in EP 2918400 B1. Each layer is inspected, and any defect is recorded in the database, and a structural integrity check is performed. If needed, instructions for correcting the defect are generated and transmitted to the workers. Information of the performed corrective action is stored in the database. This inspection system is specifically designed to cooperate with a rotating mandrel and a moveable gantry arranged on rails adjacent to the mandrel. Tacky tape strips are adhered to the substrate of the mandrel, where a compression roller presses the tape strips into contact with the substrate. Hence it cannot be implemented to cooperate with a manufacturing system for a wind turbine blade.

Other systems use an optical inspection system, such as described in WO 2015/028023 A1 and U.S. Pat. No. 8,418,560 B2, to analyse the composite structure after curing. However, these systems increase post-manufacturing work and increase the amount of waste.

### OBJECT OF THE INVENTION

One object of the present invention is to overcome the abovementioned problem of the prior art.

One object of the present invention is to provide a method and system that allows workers to locate defects in the layup structure quickly and easily.

One object of the present invention is to provide a method and system that allows an improved inspection of the layup structure.

One object of the present invention is to provide a flexible method and system that can easy be adapted to different manufacturing setups and/or interact with existing manufacturing setups.

### DESCRIPTION OF THE INVENTION

One object of the invention is achieved by a system for manufacturing a wind turbine blade, comprising:
a mould with a moulding surface, the moulding surface being shaped to form a composite structure of a wind turbine blade;
a moveable support structure arranged relative to the mould, the support structure being configured to move in at least one direction relative to the mould;
at least one measuring device arranged on the support structure, the at least one measuring device being configured to scan at least an upper layer of the composite structure and to measure topography data related to at least a top surface of the upper layer; and
a processor connected to the at least one measuring device, the processor being configured to analyse the data inputted from the at least one measuring device and determine whether defects are present in at least the upper layer or not, and the processor is further configured to determine at least the locations of said defects;
   characterised in that a lighting system is further connected to the processor and positioned relative to the mould, wherein at least the locations of the defects are transmitted to the lighting system, the lighting system comprising at least one lighting device configured to visually indicate at least the locations of the defects on or relative to the upper layer.

This provides a simple and reliable in-line inspection system for monitoring the layup process of dry fibrous layers during manufacture of composite structures. The present system is suited for the manufacture of composite structures having a laminate or sandwich structure. The present system is further suited for interaction with a manual or automated layup system, where the present system can cooperate with the layup system or function as an independent system.

The present system may also be used to perform a quality inspection of the laminate or sandwich structure after curing. Thereby allowing workers to locate defects in the cured composite structure quickly and easily that require repairs in a post-curing process. The present system allows the measuring device to move along the length of the wind turbine blade, while the lighting system visually indicates the defects on the composite structure.

Conventional robotic inspection systems are limited to automatically scanning the outer surface profile of the assembled wind turbine, where the scanned results are displayed on a remote computer station or on a computer terminal on the moveable platform. However, workers must still manually locate the defects on the outer surface.

Here, the term “topography data related to a top surface” is defined as non-contact scanning of the top surface to obtain quantifiable 2D or 3D measurements of the surface topography characteristics. The measurement techniques may include optical, microscopy, interferometry, or profilometry measurements. However, other methods of measuring the surface topography may also be used.

The processor of the present system is configured to process the inputted data from the measuring devices, and to determine one or more parameters related to the surface topography based on the inputted data. The parameters may be combined to form a 2D or 3D map of the surface topography. The processor is further configured to evaluate these parameters to identify any defects in at least the upper layer, preferably using predetermined thresholds, design parameters or other reference parameters stored in the processor and/or in the database. The defects may be wrinkles (in-plane or out-of-plane), voids, foreign objects, ply drops, or other abnormalities leading to distortions in the upper layer surface. This allows for an automated inspection of the laminate or sandwich structure to detect defects during production.

In one embodiment, the lighting devices are shaped as at least one row of lighting emitting elements arranged on the mould or positioned relative to the mould, each row of lighting emitting elements extending along at least a length of the moulding surface.

The present system comprises a lighting system connected to the processor via a wired or wireless communications link. The lighting system comprises a number of lighting devices configured to emit one or more light beams forming one or more visually identifiable patterns on or nearby the moulding surface or composite structure. The light devices are connected directly or indirectly to the processor and configured to receive data related to the results of the data analysis in the processor. The lighting devices are configured to emit light to visually indicate at least the locations of defects and/or no defects based on the received data. This allows workers to locate defects in the upper layer quickly and, if needed, perform any corrective actions.

The lighting devices may be formed by lighting emitting elements, LEDs, arranged on the mould. Preferably, at least one row of first LEDs may be arranged on a first side of the mould and/or at least one row of second LEDs may be arranged on a second side of the mould. The rows of first and second LEDs may extend along at least a portion of the length of the moulding surface, preferably along the entire length. This allows workers to locate defects and/or no defects in the length direction quickly and easily.

Optionally, at least one row of third LEDs may further extend in a transverse direction of the mould. The rows of third LEDs may be arranged on the mould adjacent to the first and/or second LEDs. This allows workers to further locate defects and/or no defects in the transverse direction quickly and easily.

The number of LEDs may be selected based on the length and/or the width of the composite structure. Each LED may define a section of the composite structure or moulding surface in the length direction and/or in the transverse direction.

In one embodiment, the lighting emitting elements are grouped in least one matrix arranged on the mould or positioned relative to the mould, each matrix of lighting emitting elements defining a plurality of sections of the composite structure in the length direction and/or in a transverse direction.

Alternatively, a matrix of first LEDs and/or a matrix of second LEDs may be arranged on the first and/or second side of the mould. The first and/or second LEDs in each matrix may be aligned in rows and columns. Preferably, the matrixes may be arranged relative to the mould surface or a mould edge. Optionally, at least one matrix of the third LEDs may further be arranged on the top surface of the mould, preferably adjacent to the matrix of first LEDs and/or second LEDs. This allows current location data and/or historical data to be visually displayed to the workers.

The rows or matrixes of first, second and/or third LEDs may also be arranged on a separate frame or support structure. The frame or support structure may be a stand-alone unit or be configured to be mounted on a wall in the floor in the working area. The frame or support structure may be positioned relative to the mould so that the worker is able to view the LEDs when moving in or around the mould. This further allows workers to view the current location data of defects and/or no defects, and optionally also historical data, in the composite structure quickly and easily during production.

In one embodiment, the lighting devices are shaped as at least one light projecting device positioned above the mould, the light projecting device being configured to project at least one light beam onto the top surface of the upper layer.

The lighting devices may also be shaped as light projecting devices positioned above the mould. Each light projecting device may be configured to emit an electromagnetic beam of light which is detectable on the top surface of the composite structure or mould by the human eye or by use of detectable elements. The detectable elements may be light reactive lenses or smart glasses. Preferably, the emitted light being visible light, such as having wavelengths between 400-700 nm and/or frequencies between 420-750 THz.

Each light projecting device may be positioned above the mould, preferably in a fixed position or on a moveable frame structure. A plurality of light projecting devices may be arranged within the working area relative to the mould so that the light projecting devices are capable of projecting light beams onto the entire composite structure or moulding surface. The light projecting device may be a laser projector, a digital projector or another type of light projector. This allows the locations of defects, a unique code associated with each defect, and/or other relevant data to be visually illustrated on the top surface, thus allowing workers to identify defects and other relevant data quickly and easily without having to manually locate and mark these positions.

The lighting system may comprise a local light controller connected to the lighting devices via wired or wireless communications links. The local light controller may further be connected to a local data processing controller in the processor. The light controller may be configured to control the operation of the lighting devices and communicate with the data processing controller and/or the database. The data processing controller may be configured to process the data inputted from the measuring devices and communicate with the light controller and/or the database. Alternatively, the light controller and the data processing controller may be implemented into a single control unit. This allows the present system to be adapted to the production setup at the working area. This further allows the data processing to be performed faster, thereby reducing the time delay between data input and data output.

The present system may interact with existing light projecting systems, such as mentioned in EP 1955108A1, capable of receiving and projecting the locations of defects onto the top surface. This reduces the amount of system components needed and saves costs. The present light controller may optionally be implemented in the control unit of the existing light projecting system.

However, conventional lighting systems, such as mentioned in EP 3645255 A1, are normally only configured for projecting reference markings for the layup of core panels or fibrous layers.

In one embodiment, the processor is connected to at least one database configured to store at least historic data related to defects in layers of the composite structure, where the processor is further configured to process the data inputted from the at least one measuring device in real-time and continuously update the location data of defects in at least the upper layer.

The processor may be implemented in a local or remote control unit, where the control unit may be connected to a local or remote database. The processor and/or the database may be implemented in a local or remote server unit. For example, the processor may be arranged as a local control unit in communication with a remote database unit. This allows for a stable data processing and data communication. Alternatively, the processor and database may be arranged as a remote server unit in communication with a local controller, e.g., of the lighting system. This allows the complex data processing to be performed remotely, while allowing a local controller to control the operation of the system and the communication between the respective electrical components. Thereby reduces the amount of local data processing.

The processor may process and analyse the data inputted from the measuring device in real-time or near real-time. Here, the term “real-time” includes processing the measurement data as it comes in. Here, the term “near real-time” includes collecting the measurement data in batches and processing the measurement data batches. The batch size may be selected as time or length intervals. The processor may thus identify defects in at least the upper layer in real-time or near real-time.

The processor is configured to at least determine the locations of any identified defects in a length direction and/or in a width direction. The location data of these defects in the upper layer may then be transmitted to and stored in the database. A local coordination system at the working area may be used to determine the locations of the defects. The database may be updated continuously as the measuring device is moved along the moulding surface, or after the completion of each run. This allows defects in the current upper layer to be easily identified while updating the historical data.

In one embodiment, the at least one measuring device is configured to continuously measure the data related to the surface topography as the support structure is moved along the moulding surface in the at least one direction.

The processor may be connected to the measuring device via a wired or wireless communications link. The measuring device may be configured to continuously transmit data to the processor, or temporary store the measured data before transmitting it to the processor. The amount of data transmission may depend on whether the data is being processed locally or remotely. Optionally, the raw data of the measuring devices may also be transmitted to and stored in the database.

The measuring device may be configured to perform a 2D or 3D measurement of the surface topography in the length and/or transverse direction. For example, the measuring device may scan the top surface by emitted an electromagnetic signal onto the top surface using one or more transmitters. The measuring device may then capture the reflected signal using one or more receivers. Alternatively, one or more cameras may be used to capture one or more images of the top surface and of an optional light pattern projected onto the top surface. The images may then be process and analysed in the processor. The measuring device may use a non-destructive imaging technique, such as ultrasound, X-ray, laminography, profilometry, digital imaging, electromagnetic radiation, or another measuring technique to measure the top surface characteristics.

The processor may be configured to process the measurement data to determine one or more parameters related to a defect as described later. The parameters may be height variations in the top surface, thickness variations of the upper layer, misplacement of the upper layer, edge detection and other relevant parameters. The processor may also be configured to determine a CTQ-level or a severity indicator associated with the defects. The CTQ-level and/or the severity indicator may also be visually indicated on or near the moulding surface or composite structure using the lighting devices.

In one embodiment, the at least one lighting device is configured to visually indicate locations where defects are identified using at least one set of colours, and optionally further to visually indicate locations where no defects are identified using at least one other set of colours.

The lighting device may be configured to emit light patterns with one or more colours to visually indicate the locations of defects and/or no defects. A first set of colours may be used to visually indicate locations of defects identified by the processor. Optionally, a second set of colours may be used to visually indicate locations where no defects are identified. Alternatively, no light may be used to visually indicate locations where no defects are identified. This allows workers to quickly locate defects in the composite structure by the colours used.

A continuous light of a selected colour with a constant intensity may be used to visually indicate the locations of defects. Alternatively, an alternating light may be used to visually indicate the locations of defects. The alternating light may be formed by emitting a selected colour with different intensities. The alternating light may also be formed by emitting different colours, each with the same intensity. The alternating light may also be formed by emitting different colours with different intensities. This allows worker to quickly identify defects and optionally detailed information thereof.

In one embodiment, the at least one lighting device is configured to visually indicate locations where defects and/or no defects are identified by emitting a continuous light, an alternating light and/or a rhythmic light with at least one period of light and at least one period of darkness.

The lighting device may be configured to further emit light patterns with a continuous or alternating light, as described above. Alternatively, the light pattern may also be emitted using a rhythmic light with at least one period of light and at least one period of darkness, where the periods of light and darkness may be selected to indicate the type of defect and/or the severity of the defect. The use of a rhythmic light may be combined with the use of different colours and/or the use of a continuous or alternating light. This allows workers to further identify details of the defects by using selected types of light.

Optionally, the above light pattern may also be adapted to visualize chordwise positions on the surface area. This allows workers to quickly and easily identify selected chordwise positions using the light pattern.

In one embodiment, the processor is configured to identify the type of defects and/or the severity of defects, preferably the processor is further configured to rank the type of defects and/or the severity of defects in accordance with one or more predetermined conditions.

The processor may be configured to classify the parameters of the identified defects in accordance with predetermined conditions, which define a number of ranking levels. Each ranking level may be associated with the type of defects, the severity of defects, the size of the defects, and/or the CTQ-level. Each ranking level may further be linked with a particular light colour, a rhythmic light, and/or a continuous or alternating light. This allows for automatic classification of the identified defects to visually how critical the defects are.

The processor may be configured to identify the ply drops, misplacement or edge detection of the upper layer(s) based on the measurements. These defects may be classified as non-critical defects and thus be visually indicated using a particular type of light that different from the other types of lights used. Thus, non-critical defects can be identified and distinguished from the other defects in a quick and simple manner.

In one embodiment, the system further comprises at least one layup tool configured to move in at least one direction relative to the mould, the layup tool being configured to apply at least one layer of a fibrous material onto the moulding surface or the upper layer.

The present system may further comprise one or more layup tools configured to apply one or more layers of fibrous material onto the upper layer, where the fibrous material may be feed from a roll. The layup tool may be arranged on a trolley extending in the transverse direction. The trolley may be moveable along a pair of rails in the length direction. The pair of rails may be arranged along the sides of the mould or adjacent to the mould. Alternatively, the trolley may be configured to move along a pair of tracks arranged on runway beams over the working area. The layup tool may further be moveable along the trolley in the transverse direction and/or moveable in the height direction relative to the trolley. This allows for at least a semi-automatic layup of the various fibrous layers, thus reducing the total layup time and providing a less labour-intensive process.

The trolley may comprise a dual layup tool capable of applying a fibrous layer in both length directions. Each individual layup tool may be feed from individual rolls of fibrous material. Each individual layup tool may be operated individually so the layup process can be performed in both length directions. This further reduces the total layup time.

The layup tool may be configured to be connected to a cart on rails, a robotic arm or directly to a beam of a crane system. The crane system may be a gantry crane or overhead crane. The layup tool may form part of a semi-automated or automated layup system. The layup tool may be moved along the moulding surface in the length direction and/or in the transverse direction. This allows layers to be applied using an automatic or semi-automatic layup process, thus reducing the total production time and reducing the risk of defects due to human errors.

The layup tool or trolley may comprise a position sensor configured to measure the location of the layup tool, where the position sensor may be connected to the processor via a communications link. The processor may determine the location of the layup tool based on the input from the position sensor.

In one embodiment, the support structure forms part of the layup tool, wherein the measuring device is connected to the layup tool so it follows the movement of the layup tool.

The measuring device may be connected to the layup tool or trolley so it follows the movement of the layup tool or trolley. The processor may determine the position of the measuring device using the data inputted from the position sensor on the layup tool or trolley. Optionally, at least the data processing controller may be arranged on the layup tool or trolley. This allows the upper layer to be scanned while applying the fibrous layer in a combined run.

A first measuring device may be arranged at one end of the dual layup tool and a second measuring device may be arranged at an opposite end of the dual layup tool. The first and second measuring devices may both be connected to the processor. This allows the upper surface to be scanned in both length directions depending on the movement of the layup tool.

In one embodiment, the support structure is shaped as a beam or frame configured to be connected to a crane system, a trolley or a guided vehicle system, the crane system, trolley or guided vehicle system being configured to further move the beam or frame in at least one direction relative to the mould, preferably the crane system, trolley or guided vehicle system is configured to move the beam or frame independently relative to the layup tool.

The measuring device may also be arranged on a support structure configured to be connected to the crane system or trolley, on which the layup tool is located. Alternatively, the support structure may be moved along a separate crane system, a trolley or a guided vehicle system further arranged relative to the mould. The guided vehicle system may be automated guided vehicle (AGV) system. The support structure with the measuring device may thus be arranged so that it can be moved independently relative to the layup tool. This allows the scan of the upper layer and the layup of a fibrous material to be performed in separate, independent runs. For example, the scans may be performed between layups of the fibrous layers.

Conventional inspection systems use a moveable platform, e.g., a self-propelled vehicle, with a moveable holder, e.g., a robotic arm, to position and orientate the 3D scanner or scanning probes relative to the cured composite structure. However, this adds to the complexity of the overall system and requires the composite structure to be moved into a finishing area.

In one embodiment, a single measuring device or at least two measuring devices is/are arranged on the support structure in the transverse direction, wherein the measuring device(s) is/are arranged in a fixed or adjustable position and/or orientation on the support structure.

Preferably, the measuring device is an optical metrology device, such as a distance sensor, or a profilometer configured to scan at least the top surface of the upper layer. The optical metrology device or profilometer may comprise at least one light source for illuminating the upper layer. For example, a laser source or digital light source may be used to project one or more patterns onto the top surface. The optical metrology device or profilometer may further comprise at least one camera for capturing images of the inspection area. This provides a cheap and reliable measurement of the surface topography.

The processor may be configured to determine parameters of the top surface topography and/or a 2D or 3D surface profile based on the data inputted from the optical metrology device or profilometer. The processor may identify defects using a base model defining a nominal surface line or profile in the length direction and/or in the transverse direction. This allows for a simple and reliable automatic detection of defects in the processor.

The present system may use a single measuring device to scan the entire transverse width of the composite structure or moulding surface. Alternatively, two or more measuring devices may be positioned relative to each other and used to the entire transverse width of the composite structure or moulding surface. This allows the configuration of the measurement device setup to be adapted to the dimensions of the composite structure and the geometrical profile thereof.

The measuring device(s) may preferably be arranged on the support structure so that it/they are able to be scan the entire top surface of the composite structure when moved along the mould. Each measuring device may be connected to the support structure in a fixed position and fixed orientation, so the measuring device follows the movement of the support structure. Alternatively, the measuring device may be configured to rotate around a local transverse axis and/or a local length axis, so the measuring device may be orientated correctly relative to the inspection area of the top surface. This allows the measuring device to be adjusted relative to the geometrical profile of the moulding surface or composite structure during the scan.

In one embodiment, the system further comprises at least one feedback device configured to input a feedback signal to the processor, wherein the feedback device is configured to communicate with the processor directly or via the measuring device or lighting system.

The present system may further comprise one or more feedback devices so the workers may input feedback signals in a quick and simply manner without having to manually enter information on a central terminal.

The feedback devices may be one or more buttons, such as push buttons, arranged along the rows of LEDs. The buttons may be distributed along the length of the LEDs and may be connected to the processor for inputting one or more feedback signals. The feedback signal may for example indicate the approval of a selected portion of the upper layer. This allows workers to input feedback signals in a quick and simple manner.

The feedback devices may be one or more handheld devices, such as smartphones, phablets, tablets or remote controllers, configured to communicate with the processor via a wireless or wired communications link. A user interface, such as a graphic user interface (GUI), on the handheld devices may be used to input the feedback signals and/or to receive detailed information related to a selected defect. Optionally, the handheld devices may be configured to scan a selected unique code illustrated on the top surface. This allows workers to input feedback signals as well as view detailed information in a quick and simple manner.

Alternatively, the feedback devices may be one or more smart glasses configured to communicate with the processor via a wireless or wired communications link. The smart glasses may be configured to receive data related to the defects from the processor, such as location data, historical data, instructions for corrective actions, or other relevant data. This allows workers to receive detailed information related to a selected defect while continue interacting with the composite structure. The workers may input feedback signals via the smart glasses, which may be transmitted back to the processor. This also allows workers to input feedback signals as well as view detailed information in a quick and simple manner.

Alternatively, the feedback devices may be one or more reflective devices configured to reflect feedback signals back to the light projecting devices. The reflective devices may each comprise a unique code incorporated into the reflective pattern. The processor, or the light controller, may be configured to detect the reflected signals and decode the feedback signal. This allows workers to input feedback signals by simply positioning the reflective devices within the illustrated areas on the top surface.

In one embodiment, the composite structure is a spar cap, a shear web, a trailing edge reinforcement, a leading edge reinforcement, a blade shell part, or a blade root part.

The present system is suited for use when manufacturing large composite structures, such as wind turbine blades. The mould surface of the mould may be shaped to form a wind turbine blade component. The wind turbine blade component may be a spar cap, a shear web, a trailing edge reinforcement, a leading edge reinforcement, a suction side blade shell, a pressure side blade shell, or a blade root section.

The present system may be incorporated into existing automated layup systems to reduce the number of components and reduce installation costs. Alternatively, the present system may be implemented as a stand-alone inspection system.

One object of the present invention is also achieved by a method of manufacturing a wind turbine blade, comprising:
arranging layers of a composite structure of the wind turbine blade on a moulding surface of a mould, the composite structure having a laminate or sandwich structure;
scanning at least an upper layer of the composite structure using at least one measuring device, transmitting topography data related to at least the top surface of the upper layer to a processor;
analysing the data inputted from the measuring device in the processor, wherein the processor determines whether defects are present in at least the upper layer or not, and further determines at least the locations of said defects;
transmitting at least the locations of the defects to a lighting system, where at least the locations of the defects are visually indicating on or relative to the upper layer using a lighting system.

This provides an improved method for inspecting a composite structure of a wind turbine blade, which can be used during layup of the dry layers of the composite structure as well as in a post-curing process. The present method can be implemented together existing automatic layup systems to save installation costs and reduce the total number of components.

The top surface is scanned as the measuring device is moved along the moulding surface or composite structure. The data from the measuring device is then processed and analysed in the processor, which transmits at least the location data of the defects to the lighting system. The lighting system visually indicates the locations of these defects to the workers so defects in the upper layer can be quickly identified and repaired if needed.

Conventional automated inspection systems are limited to scan the assembled wind turbine blade in a finishing step, where the platform is along the floor while scanning the outer surface of the wind turbine blade. The scan results are displayed in real-time on a computer terminal on the platform or at a remote computer station. Information about defects needs to be relayed to the workers either manually or via handheld computer devices, which then must manually find and repair these defects before the coating can be applied.

Other conventional inspection systems utilise a portable, handheld scanner tool that scans a small surface area and projects the results on the surface using colours.

In one embodiment, the locations of the defects are visually indicated along a length of the mould using lighting emitting elements of the lighting system, the lighting emitting elements defining a plurality of sections of the composite structure in the length direction and/or in a transverse direction.

The rows of first and/or second LEDs in the matrixes may be used to visually indicate the current locations of defects and/or no defects in the entire upper layer. The rows of first and/or second LEDs in the matrixes may also be used to visually indicate historical data of defects and/or no defects in one or more layers. The LEDs may be positioned on the mould or on a separate frame or support structure located relative to the mould. This allows workers to visually view the locations of defects and/or historical data in the upper layer during layup or in the post-curing process.

The LEDs may be positioned on existing moulds and may be assembled into the desired length in a quick and easy manner, thus allowing for a fast and simple installation.

In one embodiment, the locations of the defects are visually indicated on the top surface of the upper layer using at least one light projecting device of the lighting system, the light projecting device projecting at least one light pattern onto the top surface of the upper layer.

The locations of defects may also be visually indicated on the top surface by emitting light patterns from the light projecting devices. Each light projecting device may emit one or more light patterns onto the top surface within a projected area, thus allowing workers to visually locate multiple defects in the upper layer. Preferably, the combined projected areas of the light projecting devices may correspond to at least the entire top surface of the composite structure.

The light pattern may be a boundary line around the defect, a local width and local length of the defect, and/or the surface area of a defect. Other light patterns may also be used. The emitted light pattern may be corrected for the angle between the light projecting device and the top surface.

If light projecting devices are already installed over the working area, then these light projecting devices may be used to visually indicate the locations of the defects. The present light controller may then be implemented into or communicate with the existing light controller. This allows defects as well as layup patterns to be visually illustrated on the top surface.

In one embodiment, the data is analysed by the processor in real-time and/or the locations of the defects are visually indicated by the lighting system in real-time.

The data from the measuring devices may be transmitted to the processor and processed in real-time. The raw data of the measuring devices may optionally also be stored in the database. The processor may determine the parameters of the surface topography in real-time, and further identify defects in at least the upper layer in real-time. The location data of defects, type of defects, severity of defects and other historical data may be continuously stored in the database. This allows defects to be identified in real-time.

The location data of defects, historical data and other data may be transmitted to the lighting system, where the lighting devices visually indicate the locations of defects and optionally other data in real-time. This allows worker to quickly isolate and start repairing defects in at least the upper layer of the composite structure. This saves time during production as corrective actions can be performed during the dry layup.

In one embodiment, the defects are ranked by the processor in accordance with one or more predetermined conditions, wherein each ranking level is associated with a different set of colours and/or with a different rhythmic frequency.

The processor may evaluate the measured surface topography parameters to provide detailed information about the identified defects. The defects may be classified according to predetermined ranking conditions, such as the height, width and/or length of defect, the type of defect, the severity of defect, or other conditions. Each ranking level may be associated with a set of colours, a rhythmic frequency, and/or an intensity of the emitted light. This allows details about the defects to be visually indicated to the workers via the emitted light and/or light pattern.

This detailed information allows workers to carry out corrective actions for each defect more effectively as the need for manual evaluation of each defect is reduced.

In one embodiment, the composite structure extends from a first end to a second end in a length direction and further from a first edge to a second edge in a width direction, where the scanning of the top surface is performed as the measuring device is moved along the length direction, wherein the scanning is further performed over at least a portion of the width of the composite structure and/or over at least a portion of the length of the composite structure.

The scanning may be performed only along a portion of the total surface area, preferably along the surface area of the upper layer where the next fibrous layer is planned to be arranged or along critical portions of the surface area. The scanning may also be performed over another surface area of interest. Two or more runs of the measuring device may be performed for scanning the entire surface area of a selected layer of the composite structure. Alternatively, the entire surface area of a selected layer of the composite structure may be performed in a single run. The historical data may be updated after each run or continuously. This allows for a flexible scanning of the top surface.

The orientation of the measuring device may be adjusted in the length direction and/or in the transverse direction to orientate the measuring device correctly relative to the top surface during the scan. This adjustment may be performed manually or automatically.

In one embodiment, the scanning of the top surface is performed simultaneously with laying up at least one layer of a fibrous material onto the upper layer.

The scan of the top surface and the layup of a fibrous layer may be performed simultaneously in a combined step. The measuring device may scan the former upper layer just before layup or the measuring device may scan the latter upper layer after the layup, depending on the location of the measuring device. This reduces the total number of production steps.

Arranging layers of the composite structure on the moulding surface includes laying up at plurality of layers of a fibrous material onto a moulding surface of a mould, where the layers together form a composite structure of the wind turbine blade. The layers of fibrous material may form the inner skin, the outer skin and/or a laminate of layers of the composite structure. This allows the scanning to be performed during the dry layup of the respective layers forming the composite structure. Thereby increases the quality of the layup and reduces the total number of defects occurring in the composite structure after curing.

In one embodiment, the scanning of the top surface is performed after laying up at least one layer of a fibrous material onto the upper layer, and optionally before laying up at least one further layer of a fibrous material.

Arranging layers of the composite structure on the moulding surface also includes laying up all layers of the composite structure, infusing the layers with a resin matrix material and curing the infused layers to form a cured structure. This allows the scanning to be performed on the cured composite structure in a post-curing process.

This may be done while the cured composite structure is still in the mould or after it is moved to a finishing area. This also allows for the same inspection system to be used during layup as well as after curing, thereby increasing the flexibility of the present system and reduces costs.

In one embodiment, the method further comprises the step of inputting at least one feedback signal to the processor, preferably via a graphic user interface, the feedback signal being indicative of that at least one predetermined action has been performed in relation to a selected defect.

The worker may use a handheld or mobile device to input an electronic feedback signal into the system, as described earlier. The user interface of the handheld or mobile device may be configured to allow for quick and easy input of a feedback signal. The feedback signal may be a false positive signal, a corrective action completed signal, a keep monitoring signal, or another feedback signal. This allows for a quick and easy input of feedback signals.

The workers may also input feedback signals using reflective feedback device with an integrated unique code. Feedback signals may be inputted by simply positioning the reflective device relative to a selected defect within the illuminated area of the light projecting device. The processor may then read the reflected code and store the feedback signal together with the details of that defect.

The workers may also input feedback signals via the smart glasses, which may be transmitted back to the processor. Voice commands or push buttons may be used to input feedback signals to the smart glasses. Optionally, the smart glasses may be configured to scan the top surface and detect light patterns projected onto the upper layer. The light pattern may be a unique code (barcode or QR-code) and/or the locations of the defects.

This allows for a handsfree workflow during production.

In one embodiment, historic data related to defects in a particular layer of the composite structure is stored in a database after each scan, preferably feedback signals inputted to the processor are further stored in the database.

The data from the measuring device may be stored in the database, where data related to the defects in that layer may also be stored. This data may be updated for each run of the measuring device. Any feedback signals may also be stored in the database.

Detailed information about the corrective action may be further stored in the database. This detailed information be accessed via the handheld or mobile device or the smart glasses.

In one embodiment, historical data related to defects in at least one former layer is transmitted to the lighting system by the processor, wherein the lighting device is visually indicating the historical data, preferably together with current data related to defects in the upper layer.

The historical data may be visually illustrated in a first-in-first-out (FIFO) order, preferably updated after each run of the measuring device. Alternatively, the historical data may be visually illustrated upon request. Alternatively, the historical data may be visually illustrated by switching between different historical data after a predetermined time period. This allows historical data of interest to be visually indicated to the workers.

The historical data and/or the detailed information may further be displayed in real-time or near-real time in the user interface. This allows the results of the data processing to be displayed quickly and easily to the workers.

### DESCRIPTION OF THE DRAWING

The invention is described by example only and with reference to the drawings, wherein:

FIG. 1 shows an exemplary embodiment of a wind turbine,

FIG. 2 shows an exemplary embodiment of the wind turbine blade,

FIG. 3 show shows a first embodiment of a system for manufacture of a composite structure of the wind turbine blade,

FIG. 4 shows the mould and a prior art trolley with a dual layup tool,

FIG. 5 shows an exemplary embodiment of the trolley with the dual layup tool according to the invention,

FIG. 6 shows an exemplary embodiment of a light beam projected onto the top surface,

FIGS. 7a-b show two alternative configurations of the measuring device on the support structure,

FIG. 8 shows the trolley being moved along the moulding surface while defects are visually indicated in real-time,

FIG. 9 shows a matrix of light emitting devices arranged on the mould,

FIG. 10 shows a matrix of light emitting devices arranged on a separate support structure, and

FIG. 11 shows a feedback device interacting with the projected light pattern on the top surface of the upper layer.

In the following text, the figures will be described one by one, and the different parts and positions seen in the figures will be numbered with the same numbers in the different figures. Not all parts and positions indicated in a specific figure will necessarily be discussed together with that figure.

### DETAILED DESCRIPTION OF THE INVENTION

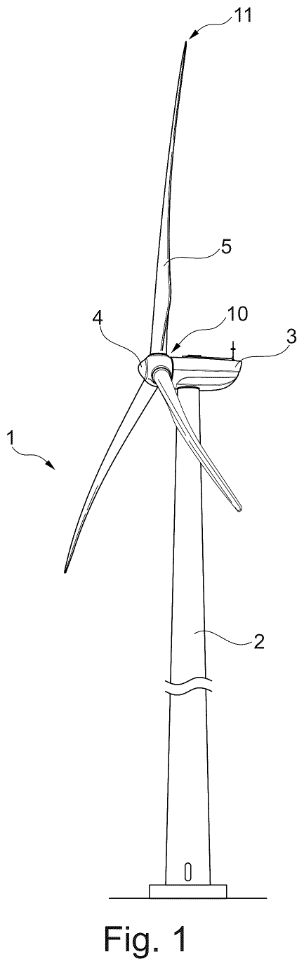

FIG. 1 shows an exemplary embodiment of a wind turbine 1 comprising a wind turbine tower 2, a nacelle 3 arranged on top of the wind turbine tower 2, and a rotor connected to a drive train in the nacelle 3. The rotor comprises a hub 4 and at least one wind turbine blade 5 connected to the hub 4. Here, three wind turbine blades 5 are shown, but the hub may be connected to more or less wind turbine blades.

The wind turbine 1 is here shown as an onshore wind turbine, but the wind turbine 1 may also be an offshore wind turbine 1. The wind turbine blade may be a continuous wind turbine blade or a modular wind turbine blade.

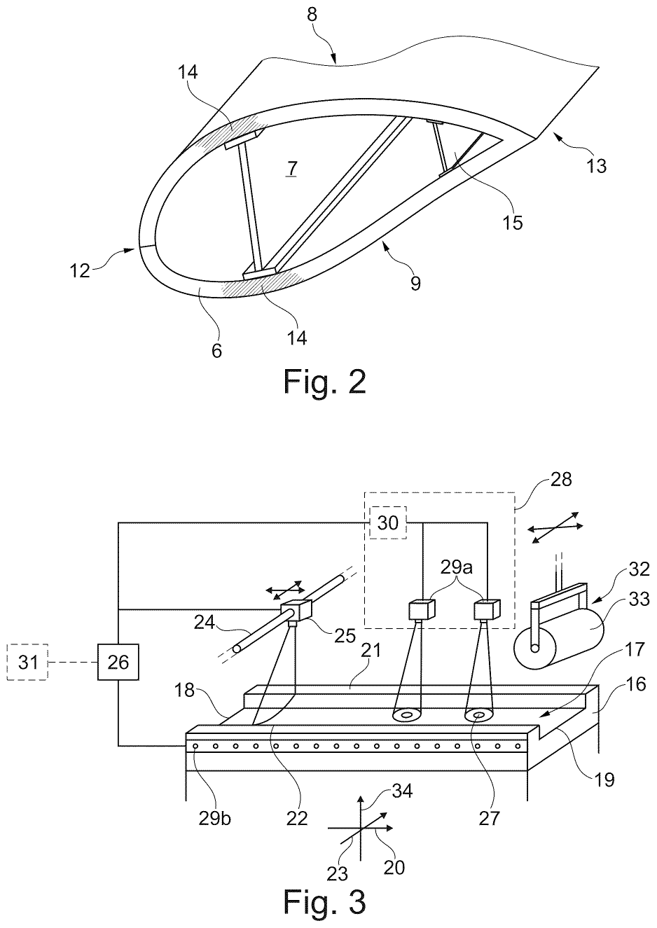

FIG. 2 shows a blade shell 6 of the wind turbine blade 5, where the blade shell 6 forms a pressure side 9 and a suction side 8. The blade shell 6 extends between a first end 10, e.g., the root end, and a second end 11, e.g., the tip end, in a length direction, as illustrated in FIG. 1. The blade shell 6 further extends between a first edge 12, e.g., the leading edge, and a second edge 13, e.g., the trailing edge, in a chord direction, as illustrated in FIG. 2.

A spar cap 14 is bonded to or integrated into the blade shell part forming the pressure side 9. Further, another spar cap 14 is bonded to or integrated into the blade shell part forming the suction side 8. One or both spar caps 14 may be formed as a single, continuous spar cap or a split spar cap. The split spar cap may optionally be joined at or near the second end 11.

A shear web 7 extends between the spar caps 14 in a thickness direction. The shear web 7 is bonded to or integrated into the spar caps 14 at the respective web interfaces. The shear web 7 may be formed as a single shear web or dual shear webs. The dual shear webs may be spaced apart in the chord direction.

Optionally, one or more reinforcement webs 15 are further arranged within the blade shell 6. The reinforcement webs 15 are positioned at a distance from the first edge 12 and/or the second edge 13. The reinforcement webs 15 are bonded to or integrated into the blade shell part forming the pressure side 9 and/or the suction side 8.

FIG. 3 shows a first embodiment of a system for manufacture of a composite structure of the wind turbine blade 5. The system comprises a mould 16 with a moulding surface shaped to form the profile of the composite structure 17. The composite structure 17 and thus the moulding surface extend between a first end 18 and a second end 19 in a length direction 20. The composite structure 17 and thus the moulding surface further extend between a first edge 21 and a second edge 22 in a width direction 23.

A moveable support structure 24 is arranged relative to the mould 16, where the support structure 24 is configured to move in at least one direction 20, 23 relatives to the mould 16. At least one measuring device 25 is arranged on the support structure 24, where the measuring device 25 is configured to scan at least the upper layer of the composite structure 17 and to measure surface topography data related to at least the top surface of the upper layer.

A processor 26 is connected to the measuring device 25 via a communications link. The processor 26 is configured to analyse the data inputted from the measuring device 25 and to determine whether defects 27 are present in at least the upper layer or not. The processor 26 is further configured to determine at least the locations of the defects. Preferably, the processor 26 is configured to determine the locations, severity and/or type of the defects 27. Historical data and other data related to the defects 27 is optionally stored in a database 31 connected to the processor 26 via a communications link.

A lighting system 28 is connected to the processor 26 via a communications link. The lighting system 28 comprises a number of lighting devices 29 each positioned relative to the mould 16. At least the locations of the defects 27 are transmitted from the processor 26 to the lighting system 28, e.g., to a light controller 30. The lighting devices 29 are configured to visually indicate at least the locations of the defects 27 on or relative to the upper layer.

Optionally, the present system comprises a layup tool 32 configured to be connected directly or indirectly to a crane system (not shown) positioned relative to the mould 16. The layup tool 32 comprises a roll of a fibrous material 33 and is configured to apply a fibrous layer onto the moulding surface or the upper layer. The applied fibrous layers form part of a laminate or sandwich structure of the composite structure 17 in the height direction 34. The crane system is configured to move the layup tool 32 in at least one direction 20, 23 relatives to the mould 16.

Here, the support structure 24 is shaped as a beam configured to be connected to the crane system. The crane system is configured to further move the beam in at least one direction 20, 23 relatives to the mould 16. Preferably, the crane system is configured to enable independent movement of the beam and of the layup tool 32.

The layup tool 32 and the support structure 24 may optionally be joint together to a combined structure. Thus, the measuring device 25 follows the movement of the layup tool 32.

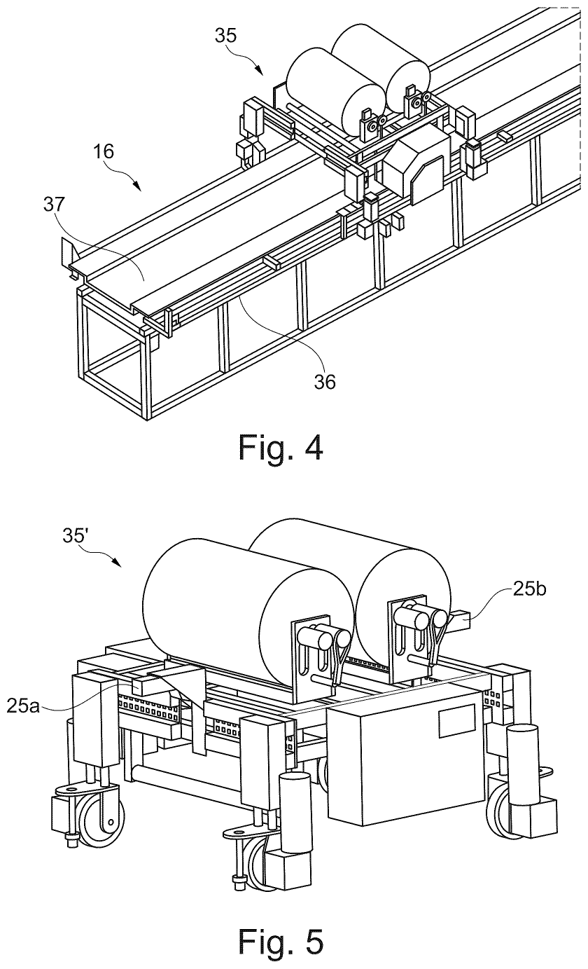

FIG. 4 shows the mould 16 and a prior art trolley 35 with a dual layup tool, where the trolley 35 is arranged on a pair of tracks 36 extending along the mould 16. The trolley 35 is thus moveable along the length of the moulding surface 37. A first layup tool with a first roll of a fibrous material 33 is used to apply a fibrous layer in one length direction. A second layup tool with a second roll of a fibrous material 33 is used to apply a fibrous layer in the opposite length direction.

FIG. 5 shows an exemplary embodiment of the trolley 35′ with the dual layup tool ac-cording to the invention. The trolley 35′ comprises a position sensor (not shown) connected to the processor 26. The processor 26 determines the location of the trolley 35′ based on data inputted from the position sensor.

A first measuring device 25a is arranged at one end of the trolley relative to the first layup tool. A second measuring device 25b is arranged at the opposite end of the trolley relative to the second layup tool. Here, the first and second measuring devices 25a, 25b are configured as optical metrology device. The configuration of the optical metrology device is known to the skilled person and will not be described in detail.

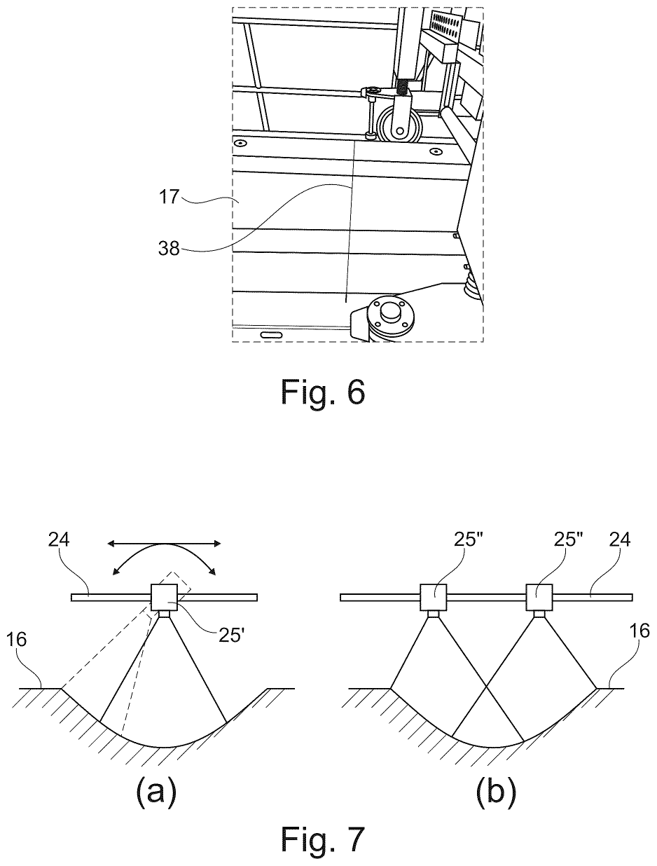

FIG. 6 shows an exemplary embodiment of a light beam 38 projected onto the top surface of the upper layer. Here, the optical metrology device is projecting a light beam, e.g., a laser beam, which are detectable by a camera located in the optical metrology device. The light beam 38 extend along the entire width of the composite structure 17

FIGS. 7a-b show two alternative configurations of the measuring device 25 on the support structure 24. A single measuring device 25′ is positioned on the support structure 24, as illustrated in FIG. 7a. The measuring device 25′ is configured to scan a portion of the upper layer in the width direction 23. The measuring device 25′ is connected to the support structure at an adjustable position. For example, the measuring device 25′ may be moved along the support structure 24 in the width direction 23 to adjust the position of the measuring device 25′ relative to the mould 16. For example, the measuring device 25′ may be rotated around a local length axis to adjust the orientation of the measuring device 25′ relative to the mould 16.

Two measuring devices 25″ are positioned on the support structure 24, as illustrated in FIG. 7b. Each measuring device 25″ is configured to scan a portion of the upper layer in the width direction 23. The data of the measuring devices 25″ are superimposed to form a combined set of data in the processor.

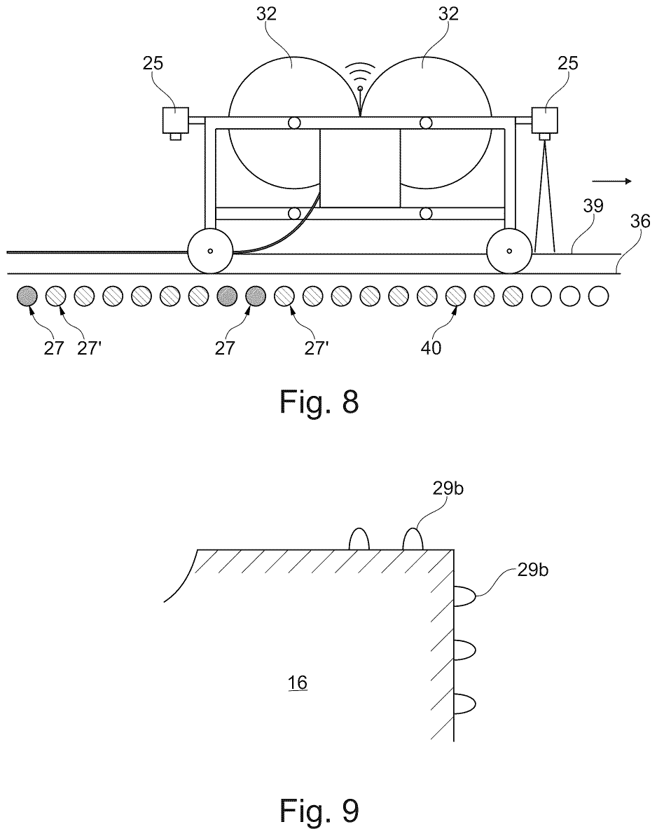

FIG. 8 shows the trolley 35′ being moved along the moulding surface 37 while defects 27 are visually indicated in real-time. The processor 26 is processing the data inputted from the measuring devices 25 in real-time and rank the defects 27, 27′ in accordance with predetermined conditions. The light emitting elements 29b are used to visually indicate locations of defects 27, 27′ and locations of no defects 40.

Critical defects 27 may be visually indicated using a first light with a selected colour, intensity and/or frequency. Less critical defects or being defects 27′ may be visually indicated using a second light with a selected colour, intensity and/or frequency. Optionally, no defects 40 may be visually indicated using a third light with a selected colour, intensity and/or frequency. No defects 40 may also visually by turning the light off.

FIG. 9 shows a matrix of light emitting devices 29b arranged on the mould 16. A matrix of light emitting devices 29b arranged in columns and rows is arranged on the side of the mould 16. Optionally, another matrix of light emitting devices 29b is arranged in columns and rows is arranged on the top surface of the mould 16.

The matrix of light emitting devices 29b is used to visually indicate historical data of defects 27 in the composite structure 17. The matrix of light emitting devices 29b is optionally also used to visually indicate the chordwise positions of the defects 27.

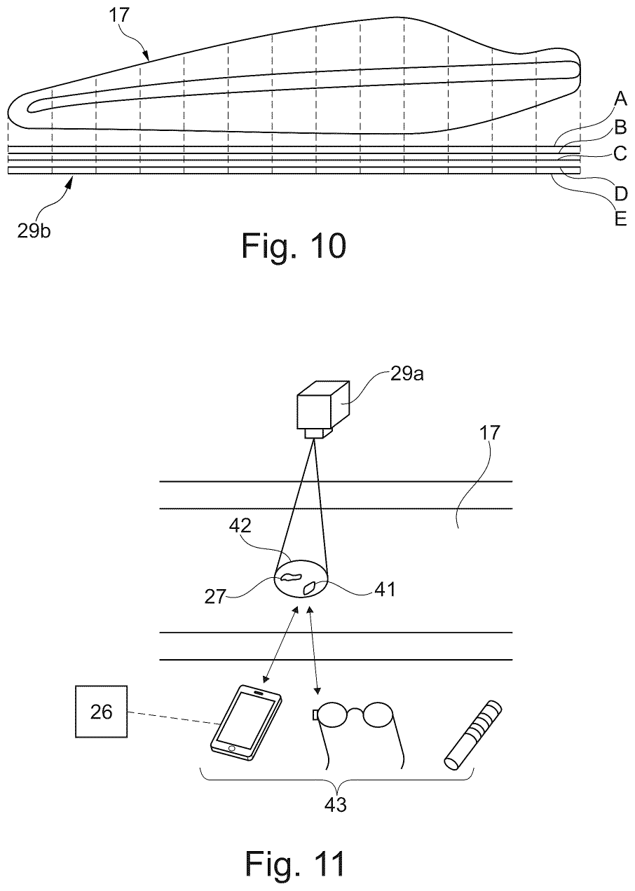

FIG. 10 shows a matrix of light emitting devices 29b, where each light emitting device 29b defines a section of the composite structure 17 in the length and width directions 20, 23. The matrix of light emitting devices 29b is optionally arranged on a separate frame structure, which is positioned relative to the mould 16.

The number of individual rows and columns is adapted to the geometrical dimensions of the composite structure 17. Here, a first row of light emitting devices 29b is indicative of a trailing edge area. A second row of light emitting devices 29b is indicative of an intermediate area between the trailing edge area and the spar cap area. A third row of light emitting devices 29b is indicative of the spar cap area. A fourth row of light emitting devices 29b is indicative of an intermediate area between the spar cap area and a leading edge area. A fifth row of light emitting devices 29b is indicative of the leading edge area.

FIG. 11 shows a feedback device 43 interacting with the projected light pattern on the top surface of the upper layer. The light projecting device 29a project a light pattern indicate the location of a defect 27 onto the upper layer of the composite structure 17. The light projecting device 29a optionally further project a unique code 41 associated with that defect 27. The unique code 41 is linked to detailed information about the defect 27 stored in the database 31.

The feedback device 43 may be a handheld communications device, such as a smartphone or smart glasses configured to scan the unique code 41 and to display detailed information stored in the database 31 to the user. The handheld communications device is connected to the processor 26 via a communications link.

The feedback device 43 may be a reflective device with a unique code incorporated in the reflective pattern. The reflective device is positioned within the illustrated area 42 of the light projecting device 29a. The light projecting device 29a is configured to detect the reflective signal of the reflective device, where the processor 26 reads the unique code and performs instructions associated with this unique code. The instructions may in example be to store a feedback signal together with the data related to that defect 27.

1. A system for manufacturing a wind turbine blade (5), comprising:
a mould (16) with a moulding surface (37), the moulding surface (37) being shaped to form the profile of a composite structure (17) of the wind turbine blade (5);
a moveable support structure (24) arranged relative to the mould (16), the support structure (24) being configured to move in at least one direction relative to the mould (16);
at least one measuring device (25) arranged on the support structure (24), the at least one measuring device (25) being configured to scan at least an upper layer of the composite structure (17) and to measure topography data related to at least the upper layer; and
a processor (26) connected to the at least one measuring device (25), the processor (26) being configured to analyse the data inputted from the at least one measuring device (25) and determine whether defects (27) are present in at least the upper layer or not, and the processor (26) is further configured to determine at least the locations of said defects (27);
wherein a lighting system (28) is further connected to the processor (26) and positioned relative to the mould (16), wherein at least the locations of the defects (27) are transmitted to the lighting system (28), the lighting system (28) comprising at least one lighting device (29) configured to visually indicate at least the locations of the defects (27) on or relative to the upper layer.

2. The system according to claim 1, wherein the lighting device (29) is shaped as at least one row of lighting emitting elements (29b) arranged on the mould (16) or positioned relative to the mould (16), each row of lighting emitting elements (29b) extending along at least a length of the moulding surface (37).

3. The system according to claim 2, wherein the lighting emitting elements (29b) are grouped in least one matrix arranged on the mould (16) or positioned relative to the mould (16), each matrix of lighting emitting elements (29b) defining a plurality of sections of the composite structure (17) in the length direction and/or in a transverse direction.

4. The system according to claim 1, wherein the lighting device (29) is shaped as at least one light projecting device (29a) positioned above the mould (16), the light projecting device (29a) being configured to project at least one light beam onto the top surface of the upper layer.

5. The system according to claim 1, wherein the processor (26) is connected to at least one database (31) configured to store at least historic data related to defects (27) in layers of the composite structure (17), where the processor (26) is further configured to process the data inputted from the at least one measuring device (25) in real-time and continuously update the location data of defects (27) in at least the upper layer.

6. The system according to claim 1, wherein the at least one measuring device (25) is configured to continuously measure the data related to the surface topography as the support structure (24) is moved along the moulding surface (37) in the at least one direction.

7. The system according to claim 1, wherein the at least one lighting device (29) is configured to visually indicate locations where defects (27) are identified using at least one set of colours, and optionally further to visually indicate locations where no defects (40) are identified using at least one other set of colours.

8. The system according to claim 1, wherein the at least one lighting device (29) is configured to visually indicate locations where defects (27) and/or no defects (40) are identified by emitting a continuous light, an alternating light and/or a rhythmic light with at least one period of light and at least one period of darkness.

9. The system according to claim 1, wherein the processor (26) is configured to identify the type of defects (27) and/or the severity of defects (27), preferably the processor (26) is further configured to rank the type of defects (27) and/or the severity of defects (27) in accordance with one or more predetermined conditions.

10. The system according to claim 1, wherein the system further comprises at least one layup tool (32) configured to move in at least one direction relative to the mould (16) the layup tool (32) being configured to apply at least one layer of a fibrous material (33) onto the moulding surface (37) or the upper layer.

11. The system according to claim 10, wherein the support structure (24) forms part of the layup tool (32), wherein the measuring device (25) is connected to the layup tool (32) so it follows the movement of the layup tool (32).

12. The system according to claim 10, wherein the support structure (24) is shaped as a beam or frame configured to be connected to a crane system, a trolley or a guided vehicle system, the crane system, trolley or guided vehicle system being configured to further move the beam or frame in at least one direction relative to the mould (16), preferably the crane system, trolley or guided vehicle system is configured to move the beam or frame independently relative to the layup tool (32).

13. The system according to claim 1, wherein a single measuring device (25) or at least two measuring devices (25) is/are arranged on the support structure (24) in the transverse direction, wherein the measuring device(s) is/are arranged in a fixed or adjustable position and/or orientation on the support structure (24).

14. The system according to claim 1, wherein the system further comprises at least one feedback device (43) configured to input a feedback signal to the processor (26), wherein the feedback device (43) is configured to communicate with the processor (26) directly or via the measuring device (25) or lighting system (28).

15. The system according to claim 1, wherein the composite structure (17) is a spar cap (14), a shear web (7), a trailing edge reinforcement (15), a leading edge reinforcement (15), a blade shell part, or a blade root part.

16. A method of manufacturing a wind turbine blade (5), comprising:
arranging layers of a composite structure (17) of the wind turbine blade (5) on a moulding surface (37) of a mould (16), the composite structure (17) having a laminate or sandwich structure;
scanning at least an upper layer of the composite structure (17) using at least one measuring device (25), transmitting topography data related to at least the top surface of the upper layer to a processor (26);
analysing the data inputted from the measuring device (25) in the processor (26), wherein the processor (26) determines whether defects (27) are present in at least the upper layer or not, and further determines at least the locations of said defects (27);
transmitting at least the locations of the defects (27) to a lighting system (28), where at least the locations of the defects (27) are visually indicating on or relative to the upper layer using a lighting system (28).

17. The method according to claim 16, wherein the locations of the defects (27) are visually indicated along a length of the mould (16) using lighting emitting elements (29b) of the lighting system (28), the lighting emitting elements (29b) defining a plurality of sections of the composite structure (17) in the length direction and/or in a transverse direction.

18. The method according to claim 16, wherein the locations of the defects (27) are visually indicated on the top surface of the upper layer using at least one light projecting device (29a) of the lighting system (28), the light projecting device (29a) projecting at least one light pattern onto the top surface of the upper layer.

19. The method according to claim 16, wherein the data is analysed by the processor (26) in real-time and/or the locations of the defects (27) are visually indicated by the lighting system (28) in real-time.

20. The method according to claim 16, wherein the defects (27) are ranked by the processor (26) in accordance with one or more predetermined conditions, wherein each ranking level is associated with a different set of colours and/or with a different rhythmic frequency.

21. The method according to claim 16, wherein the composite structure (17) extends from a first end to a second end in a length direction and further from a first edge to a second edge in a width direction, where the scanning of the top surface is performed as the measuring device (25) is moved along the length direction, wherein the scanning is performed over at least a portion of the width of the composite structure (17) and/or over at least a portion of the length of the composite structure (17).

22. The method according to claim 16, wherein the scanning of the top surface is performed simultaneously with laying up at least one layer of a fibrous material (33) onto the upper layer.

23. The method according to claim 16, wherein the scanning of the top surface is performed after laying up at least one layer of a fibrous material (33) onto the upper layer, and optionally before laying up at least one further layer of a fibrous material (33).

24. The method according to claim 16, characterised in that the method further comprises the step of inputting at least one feedback signal to the processor (26), preferably via a graphic user interface, the feedback signal being indicative of that at least one predetermined action has been performed in relation to a selected defect.

25. The method according to claim 16, wherein historic data related to defects (27) in a particular layer of the composite structure (17) is stored in a database after each scan, preferably feedback signals inputted to the processor (26) are further stored in the database.

26. The method according to claim 25, wherein historical data related to defects (27) in at least one former layer is transmitted to the lighting system (28) by the processor (26), wherein the lighting device (29) is visually indicating the historical data, preferably together with current data related to defects (27) in the upper layer.
